(19) United States
(12) Patent Application Publication
(10) Pub. No.: US 2025/0052890 A1
(43) Pub. Date: Feb. 13, 2025

(54) OBJECT-BASED DISTANCE MONITORING METHOD AND SYSTEM, AND MEDIUM

(71) Applicant: Luxshare Precision Industry Company Limited, SHENZHEN (CN)

(72) Inventors: GUANHSIUNG WANG, SHENZHEN (CN); Wei Hsin CHEN, SHENZHEN (CN)

(73) Assignee: Luxshare Precision Industry Company Limited, SHENZHEN (CN)

(21) Appl. No.: 18/782,592

(22) Filed: Jul. 24, 2024

(30) Foreign Application Priority Data
Aug. 7, 2023 (CN) 202310989824.5

(51) Int. Cl. G01S 13/86; G01S 13/91; G06V 10/25; G06V 10/56; G06V 20/52; G06V 40/10; G08B 21/02

(52) U.S. Cl. CPC G01S 13/867; G01S 13/91; G06V 10/25; G06V 10/56; G06V 20/53; G06V 40/10; G08B 21/02; G06V 2201/07

(57) ABSTRACT

Provided are an object-based distance monitoring method and system, and a medium. The method includes the following: A target body region of a to-be-monitored object in an infrared thermal image is determined based on acquired color temperature of the infrared thermal image; echo signal information near a target detection point in the to-be-monitored object is received, where the target detection point is a central point of a target axis in the target body region of the to-be-monitored object, and the echo signal information is information about an echo signal corresponding to a radar signal emitted near the target detection point; and relative distance information of a target to-be-monitored object is determined based on the echo signal information, and in a case where the relative distance information of the target to-be-monitored object does not satisfy preset distance information, an alarm signal is generated to perform an early warning processing.

### CROSS-REFERENCE TO RELATED APPLICATIONS

This application claims priority to Chinese patent application No. 202310989824.5 filed with the China National Intellectual Property Administration (CNIPA) on Aug. 7, 2023, the disclosure of which is incorporated herein by reference in its entirety.

### TECHNICAL FIELD

The present disclosure relates to the technical field of risk early warnings and, in particular, an object-based distance monitoring method and system, and a medium.

### BACKGROUND

In recent years, with the increasing acceleration of the urbanization process, the number of people has increased, and trampling incidents of high-density crowds frequently occur.

For the trample prevention monitoring of foot traffic at present, in the related art, on one hand, a method of manually counting the traffic is adopted for monitoring, but the monitoring cost is relatively high, and negligence of the manual operation cannot be avoided. On the other hand, optical or radar correlation technologies are adopted for monitoring, however, the influence of environmental factors is easily caused in the monitoring process, for example, the infrared can be easily affected by environmental illumination and temperature, whereby the accuracy of the monitoring result is reduced, and the potential safety hazards are increased.

### SUMMARY

The present disclosure provides an object-based distance monitoring method, apparatus and system, and a medium to improve the accuracy of the monitoring result and reduce the potential safety hazards on the basis of achieving the trample prevention monitoring for foot traffic.

According to the present disclosure, an object-based distance monitoring method is provided and includes the following steps: A target body region of a to-be-monitored object in an infrared thermal image is determined based on acquired color temperature of the infrared thermal image; echo signal information near a target detection point in the to-be-monitored object is received, where the target detection point is a central point of a target axis in the target body region of the to-be-monitored object, and the echo signal information is information about an echo signal corresponding to a radar signal emitted near the target detection point; relative distance information of a target to-be-monitored object is determined based on the echo signal information, and in a case where the relative distance information of the target to-be-monitored object does not satisfy preset distance information, an alarm signal is generated to perform an early warning processing.

According to the present disclosure, an object-based distance monitoring apparatus is provided and includes a first determination module, a reception module and a second determination module. The first determination module is configured to determine, based on acquired color temperature of an infrared thermal image, a target body region of a to-be-monitored object in an infrared thermal image. The reception module is configured to receive echo signal information near a target detection point in the to-be-monitored object, where the target detection point is a central point of a target axis in the target body region of the to-be-monitored object, and the echo signal information is information about an echo signal corresponding to a radar signal emitted near the target detection point. The second determination module is configured to determine, based on the echo signal information, relative distance information of a target to-be-monitored object, and in a case where the relative distance information of the target to-be-monitored object does not satisfy preset distance information, generate an alarm signal to perform an early warning processing.

According to the present disclosure, an object-based distance monitoring system is provided. The system includes at least one processor and a memory communicatively connected to the at least one processor. The memory stores a computer program executable by the at least one processor, and the computer program, when executed by the at least one processor, causes the at least one processor to perform the object-based distance monitoring method described in any one of the embodiments of the present disclosure.

According to the present disclosure, a computer-readable storage medium is provided. The computer-readable storage medium stores a computer instruction, and the computer instruction is configured to, when executed by a processor, implement the object-based distance monitoring method described in any one of the embodiments of the present disclosure.

The embodiments of the present disclosure provide an object-based distance monitoring method, apparatus and system, and a medium. The method includes the following steps: The target body region of the to-be-monitored object in the infrared thermal image is determined based on the acquired color temperature of the infrared thermal image; the echo signal information near the target detection point in the to-be-monitored object is received, where the target detection point is the central point of the target axis in the target body region of the to-be-monitored object, and the echo signal information is the information about the echo signal corresponding to the radar signal emitted near the target detection point; and the relative distance information of the target to-be-monitored object is determined based on the echo signal information, and when the relative distance information of the target to-be-monitored object does not satisfy the preset distance information, the alarm signal is generated to perform the early warning processing. Through the technical schemes described above, the infrared thermal image is acquired by using the integrated optical technology and the echo signal information at the target detection point in the to-be-monitored object is received by using the radar technology, the relative distance information of the target to-be-monitored object can be determined, whereby the accuracy of the monitoring result is improved and the potential safety hazards are reduced on the basis of achieving the trample prevention monitoring for foot traffic.

It should be understood that the contents described in this section are not intended to identify key or critical features of the embodiments of the present disclosure, nor intended to limit the scope of the present disclosure. Other features of the present disclosure will be readily understood from the following description.

### BRIEF DESCRIPTION OF DRAWINGS

In order to more clearly explain the technical schemes in embodiments of the present disclosure, the drawings used for describing the embodiments will be briefly introduced below. Obviously, the drawings in the following description are merely some embodiments of the present disclosure. For those of ordinary skill in the art, other drawings may also be obtained without creative labor according to these drawings.

FIG. 1 is a flowchart of an object-based distance monitoring method according to embodiment one of the present disclosure;

FIG. 2 is a schematic diagram illustrating the determination of relative distance information of a monitoring group according to embodiment one of the present disclosure;

FIG. 3 is a flowchart of an object-based distance monitoring method according to embodiment two of the present disclosure;

FIG. 4 is a schematic diagram of an object-based distance monitoring method according to embodiment two of the present disclosure;

FIG. 5 is a flowchart of a process for determining a target body region of a to-be-monitored object according to embodiment two of the present disclosure;

FIG. 6 is a flowchart of a process for determining relative distance information of a target to-be-monitored object according to embodiment two of the present disclosure;

FIG. 7 is a schematic diagram of a target body region of a to-be-monitored object according to embodiment two of the present disclosure;

FIG. 8 is a schematic diagram of determining a target detection point according to embodiment two of the present disclosure;

FIG. 9 is a schematic structural diagram of an object-based distance monitoring apparatus according to embodiment three of the present disclosure;

FIG. 10 is a schematic structural diagram of an object-based distance monitoring system according to embodiment four of the present disclosure; and

FIG. 11 is a schematic structural diagram of another object-based distance monitoring system according to embodiment four of the present disclosure.

### DETAILED DESCRIPTION

In order that those skilled in the art will better understand the schemes of the present disclosure, the technical schemes adopted, and the technical effects to be achieved by the present disclosure, the technical schemes of embodiments of the present disclosure will be clearly and completely described below in conjunction with the accompanying drawings of the embodiments of the present disclosure. Apparently, the described embodiments are merely some embodiments of the present disclosure, rather than all of the embodiments. All other embodiments obtained by those of ordinary skill in the art based on the embodiments of the present disclosure without needing creative efforts shall all fall in the scope of protection of the present disclosure.

It should be noted that the terms “first”, “second” and the like in the description and claims of the present disclosure, and in the foregoing drawings, are used for distinguishing between similar objects and not necessarily for describing a particular order or sequential order. It should be understood that the data so used are interchangeable as appropriate so that embodiments of the present disclosure described herein can be implemented in an order other than those illustrated or described herein. Moreover, the terms “include” and “have” as well as any variations thereof, are intended to cover a non-exclusive inclusion, for example, a process, a method, a system, a product, or a device that includes a series of steps or units is not necessarily limited to those steps or units expressly listed, but may include other steps or units not expressly listed or inherent to such process, method, product, or device.

### Embodiment One

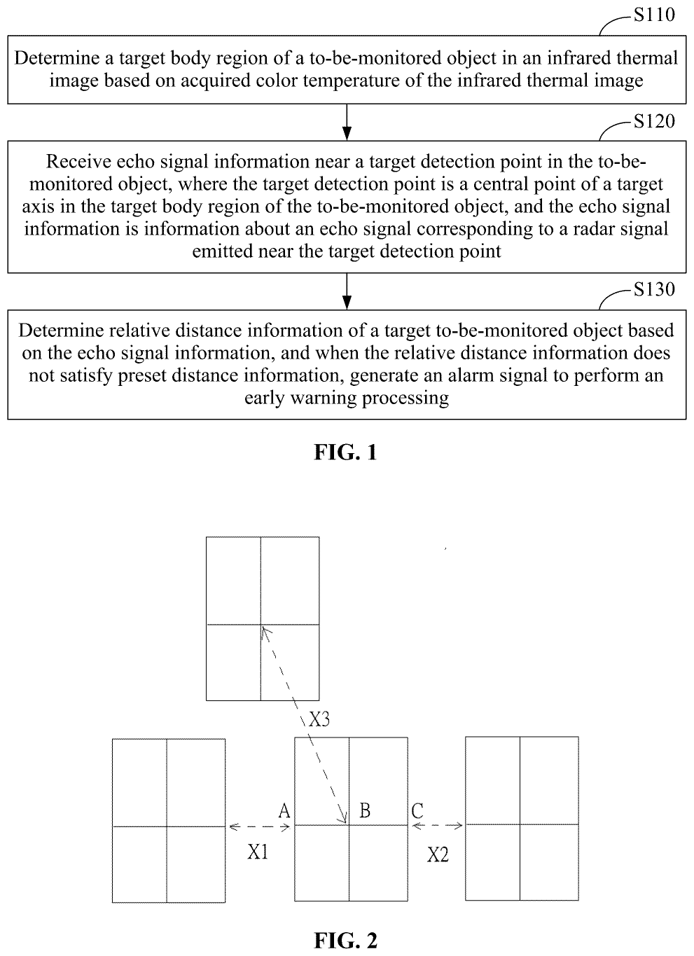

FIG. 1 is a flowchart of an object-based distance monitoring method according to embodiment one of the present disclosure. This embodiment is applicable to the case where a distance between objects needs to be monitored, the object-based distance monitoring method may be performed by an object-based distance monitoring apparatus, the object-based distance monitoring apparatus may be implemented in the form of hardware and/or software, and the object-based distance monitoring apparatus may be configured in an object-based distance monitoring system.

At present, for the object-based distance monitoring method, there are three main schemes for the trample prevention monitoring of foot traffic. The first scheme is the manual statistical method, this method is applicable to the scenario in which the personnel is more fixed and the personnel turnover is less, and when there are many entries and the instantaneous change of the increase or decrease in the personnel is too large, the monitoring cost will be increased and the probability of the negligence of the manual operation cannot be avoided. The second scheme mainly uses the optical related technologies, for example, infrared or laser radars; however, such a method is susceptible to environmental illumination and temperature effects, for example, the color temperature sensing may be affected by a temperature variation to cause excessive noise, thereby resulting in an error in the monitoring result. The third scheme may use the Doppler radar technology in the millimeter-wave radar related technologies, the radar sensing is mainly to emit radar waves in space and return radar echoes after the waves contact an object, but if other objects stand in between the test device and the target object, the measurement may be misaligned. Based on this, an embodiment of the present disclosure provides an object-based distance monitoring method, in this method, crowd congestion is detected by combining the Doppler radar and the infrared thermal image, the shortcomings of detecting foot traffic by using the infrared or the Doppler radar alone can be overcome, and the real-time crowd congestion detection is achieved by combining the advantages of the infrared and the Doppler radar. As shown in FIG. 1, the method includes the steps described below.

In S110, a target body region of a to-be-monitored object in an infrared thermal image is determined based on acquired color temperature of the infrared thermal image.

The infrared thermal image may refer to a thermal image acquired by the distance monitoring system provided in this embodiment. With respect to the infrared, the to-be-monitored object dissipates heat day or night, the heat may generate a thermal region, and the thermal region may have a temperature range so that the thermal image may be formed. A certain region in the infrared thermal image tends to be red, which represents that the temperature is higher; and a certain region in the infrared thermal image tends to be blue, which represents that the temperature is lower, such as a background object.

The to-be-monitored object may be considered as an object monitored in the infrared thermal image, and the number of to-be-monitored objects may be one or more, which is determined by the acquired infrared thermal image. The type of the to-be-monitored object is not limited, for example, the to-be-monitored object may be a living object, such as a human or an animal, and may also be an article. The target body region may be understood as a body region of the to-be-monitored object that is cut from the infrared thermal image.

In this embodiment, the target body region of the to-be-monitored object in the infrared thermal image is determined based on the acquired color temperature of the infrared thermal image. The process of determining the target body region is not limited, for example, the to-be-monitored object in the infrared thermal image may be determined first, and the target body region of the to-be-monitored object is determined directly according to the color change of the color temperature corresponding to the to-be-monitored object in the infrared thermal image. Alternatively, the body region of the to-be-monitored object may be preliminarily divided, and then a final target body region of the to-be-monitored object is determined according to pixels not yet divided in the infrared thermal image, which is not limited in this embodiment.

In S120, echo signal information near a target detection point in the to-be-monitored object is received, where the target detection point is a central point of a target axis in the target body region of the to-be-monitored object, and the echo signal information is information about an echo signal corresponding to a radar signal emitted near the target detection point.

The target detection point may be considered as the central point of the target axis in the target body region of the to-be-monitored object, the target axis may be, for example, axes of the target body region in the vertical direction and the horizontal direction, and the target detection point is an intersection point of the two axes, that is, the target detection point is the central point of the target axis in the target body region of the to-be-monitored object. The echo signal information may refer to information about the echo signal returned by a radar signal, for example, the echo signal information may include a reception time and/or a frequency offset, and the like, and the radar signal is emitted at the target detection point.

After the target body region of the to-be-monitored object in the infrared thermal image is determined based on the above steps, in this embodiment, the target detection point in the infrared thermal image may be determined first, for example, the target detection point may correspond to the to-be-monitored object, then the corresponding radar signal is emitted for the determined target detection point to receive the echo signal returned based on the radar signal, and the subsequent step is performed according to the echo signal information of the received echo signal. The manner and type of sending the radar signal and receiving the echo signal are not limited, and may be determined according to practical conditions. For example, the sent radar signal may be a 48 GHz radar wave.

In S130, relative distance information of a target to-be-monitored object is determined based on the echo signal information, and when the relative distance information does not satisfy preset distance information, an alarm signal is generated to perform an early warning processing.

The target to-be-monitored object may refer to a certain to-be-monitored object or a certain type of to-be-monitored object, for example, the target to-be-monitored object may be human. The relative distance information may be used for representing a distance of the target to-be-monitored object relative to other objects. Other objects are objects other than the target to-be-monitored object. For example, the relative distance information may be a distance between target to-be-monitored objects, or may be a distance between a group to which the target to-be-monitored object belongs and a group to which another target to-be-monitored object belongs. Other objects may also be stationary objects such as walls.

The preset distance information may be preset distance information and is configured by a related personnel. For example, the preset distance information may include a preset safe distance, and the preset safe distance is a distance in which the target to-be-monitored object is relatively safe. In some embodiments, the preset safe distance may be 1 m.

After the echo signal information is obtained by the above-described steps, the relative distance information of the target to-be-monitored object may be determined based on the received echo signal information, and then the alarm signal may be generated when the determined relative distance information does not satisfy the preset distance information, to perform the early warning processing to prompt the target to-be-monitored object to pay attention to safety, and the like. The means for determining the relative distance information based on the echo signal information is not limited. For example, the target to-be-monitored object may be determined first, and then the relative distance information of the target to-be-monitored object may be determined based on the parameters of the echo signal information. Exemplarily, the distance between the target to-be-monitored object and the monitoring system may be determined based on the sending time of the radar signal and the reception time of the echo signal in the echo signal information, and then the relative distance information of the target to-be-monitored object may be determined according to the information such as the distance and the azimuth.

In some embodiments, the step in which the relative distance information of the target to-be-monitored object is determined based on the echo signal information includes performing a calculation on the echo signal information to obtain the relative distance information of the target detection point in the target to-be-monitored object.

In this embodiment, the calculation may be performed on the echo signal information to obtain the relative distance information of the target detection point in the target to-be-monitored object, that is, the distance of the target to-be-monitored object to all other target to-be-monitored objects may be obtained by the calculation, such as the distance between people.

In some embodiments, the step in which the relative distance information of the target to-be-monitored object is determined based on the echo signal information includes the following steps: at least two target to-be-monitored objects in the infrared thermal image are divided into two monitoring individuals; and relative distance information of each monitoring individual is determined according to echo signal information corresponding to the monitoring individual.

In some embodiments, the target to-be-monitored objects in the infrared thermal image may be divided into multiple monitoring groups to monitor the distance between a monitoring group and another monitoring group. The steps of dividing the monitoring groups and determining the relative distance information of the monitoring groups are not limited herein. Exemplarily, the target to-be-monitored objects may be divided according to the direction, for example, a preset number of target to-be-monitored objects in the horizontal direction may be divided into one monitoring group. Alternatively, a preset number of target to-be-monitored objects in the vertical direction may be divided into one monitoring group. Alternatively, the target to-be-monitored objects may also be divided according to the direction and the distance.

FIG. 2 is a schematic diagram illustrating the determination of relative distance information of a monitoring group according to embodiment one of the present disclosure. As shown in FIG. 2, the monitoring group being the crowd is used as an example, the intersection points between the center axis of the short side and the long sides of the boundary of the crowd may be marked as point A and point C, and the central point of the crowd is marked as point B, so that points A, B, and C of each monitoring group may be marked. After normalization of the crowd distance, the interval between crowds in parallel may be obtained by determining the respective interval of point A and the respective interval of point C (such as X1 and X2) to obtain the relative distance information of the monitoring group, and for crowds with near-far differences, the relative distance information of the monitoring groups may be obtained by determining a straight line interval (such as X3) of point B between the crowds.

According to the object-based distance monitoring method provided in embodiment one of the present disclosure, the target body region of the to-be-monitored object in the infrared thermal image is determined based on the acquired color temperature of the infrared thermal image; the echo signal information near the target detection point in the to-be-monitored object is received, where the target detection point is the central point of the target axis in the target body region of the to-be-monitored object, and the echo signal information is the information about the echo signal corresponding to the radar signal emitted near the target detection point; and the relative distance information of the target to-be-monitored object is determined based on the echo signal information, and when the relative distance information of the target to-be-monitored object does not satisfy the preset distance information, the alarm signal is generated to perform the early warning processing. By utilizing this method, the infrared thermal image is acquired by using the integrated optical technology and the echo signal information at the target detection point in the to-be-monitored object is received by using the radar technology so that the relative distance information of the target to-be-monitored object can be determined, and thus the accuracy of the monitoring result is improved and the potential safety hazards are reduced on the basis of achieving the trample prevention monitoring for foot traffic.

In some embodiments, before the relative distance information of the target to-be-monitored object is determined based on the echo signal information, the method further includes the following steps: Life characterization information of the to-be-monitored object is determined based on the echo signal information; whether the life characterization information satisfies preset characterization information is determined, and the to-be-monitored object whose life characterization information satisfies the preset characterization information is determined as the target to-be-monitored object.

The life characterization information is used for characterizing the life characterization of the to-be-monitored object, for example, the life characterization information may include the heartbeat frequency or the respiratory frequency. The preset characterization information may be preset and used for determining the target to-be-monitored object. For example, the preset characterization information may be characterization information corresponding to the target to-be-monitored object. In some embodiments, the preset characterization information may be the heartbeat frequency of 40 Hz to 100 Hz.

In some embodiments, the target to-be-monitored object may be determined before the relative distance information of the target to-be-monitored object is determined based on the echo signal information. Exemplarily, the life characterization information of the to-be-monitored object may be determined based on the echo signal information; whether the determined life characterization information satisfies the preset characterization information is determined; and the target to-be-monitored object is determined according to a determination result. Exemplarily, when the life characterization information satisfies the preset characterization information, it is considered that the determined life characterization information satisfies the characterization information of the object corresponding to the preset characterization information. In this case, the to-be-monitored object whose life characterization information satisfies the preset characterization information may be determined as the target to-be-monitored object. However, when the life characterization information does not satisfy the preset characterization information, it is considered that the determined life characterization information does not satisfy the characterization information of the object corresponding to the preset characterization information. At this time, the to-be-monitored object whose life characterization information does not satisfy the preset characterization information may be determined as a to-be-monitored object other than the target to-be-monitored object. Based on the above, the determination of the target to-be-monitored object is achieved, which provides a basis for subsequent determination of the relative distance information of the target to-be-monitored object.

### Embodiment Two

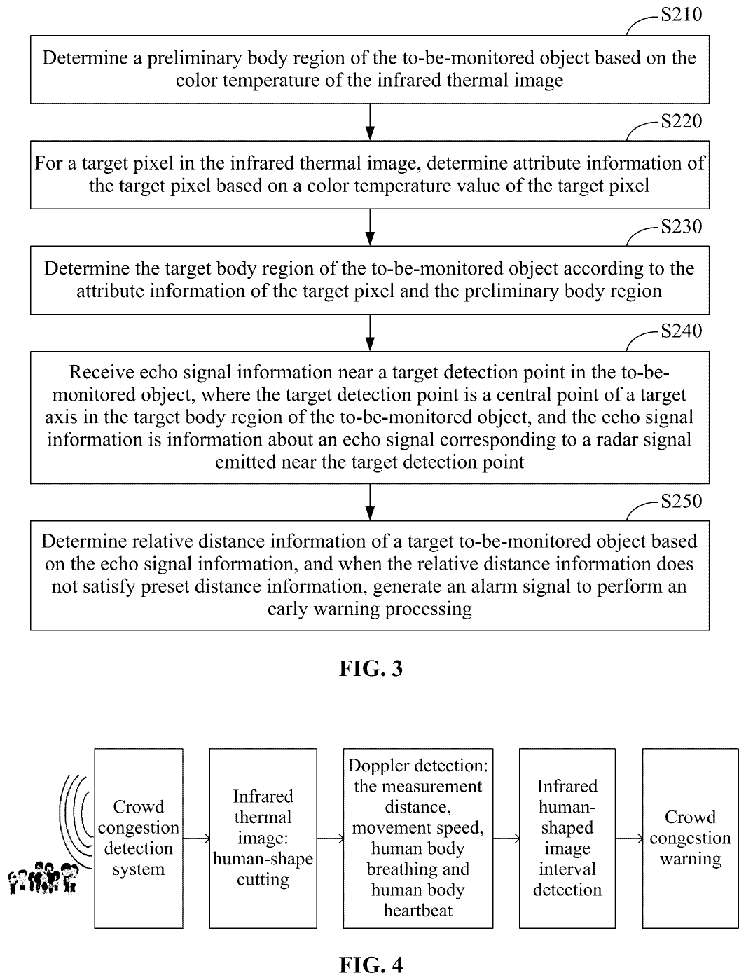

FIG. 3 is a flowchart of an object-based distance monitoring method according to embodiment two of the present disclosure, and embodiment two is optimized on the basis of the above-described embodiments. In this embodiment, the step in which the target body region of the to-be-monitored object in the infrared thermal image is determined based on the acquired color temperature of the infrared thermal image is further embodied as follows: a preliminary body region of the to-be-monitored object is determined based on the color temperature of the infrared thermal image; for a target pixel in the infrared thermal image, attribute information of the target pixel is determined based on a color temperature value of the target pixel; and the target body region of the to-be-monitored object is determined according to the attribute information of the target pixel and the preliminary body region.

For the details not yet provided in this embodiment, please refer to embodiment one.

As shown in FIG. 3, the method includes steps described below.

In S210, a preliminary body region of the to-be-monitored object is determined based on the color temperature of the infrared thermal image.

The preliminary body region may refer to a preliminarily-determined body region of the to-be-monitored object. For example, in this embodiment, the preliminary body region of the to-be-monitored object may be determined directly according to the color change of the color temperature in the infrared thermal image. It should be understood that a thermal region is formed in the infrared thermal image by an object that dissipates heat in view of the infrared. The redder the color of a thermal region represents the higher the temperature. The color of a region formed in the infrared thermal image by an object that does not dissipate heat tends to be blue. Therefore, the body region of the to-be-monitored object may be preliminarily determined according to the color and outline of the thermal region.

In S220, for a target pixel in the infrared thermal image, attribute information of the target pixel is determined based on a color temperature value of the target pixel.

The target pixel may be considered as a pixel which is in the infrared thermal image and has not been clearly divided into the to-be-monitored object or an object other than the to-be-monitored object, for example, the object other than the to-be-monitored object may be the background and the like. The attribute information is used for characterizing the attribute of the target pixel, for example, whether the target pixel belongs to the body region of the to-be-monitored object, and whether the target pixel belongs to a background region and/or an edge region.

After the preliminary body region of the to-be-monitored object is preliminarily determined, some undivided target pixels still exist in the infrared thermal image. In this step, for these target pixels, the attribute information of each target pixel is determined based on the color temperature value of the target pixel so that the target body region of the to-be-monitored object may be determined. The manner for determining the attribute information of the target pixel may be determined according to practical conditions. For example, the attribute information of the target pixel may be directly determined according to the color temperature value of the target pixel, or the attribute information of the target pixel may be determined according to the color temperature value of the target pixel and also the color temperature values of pixels around the target pixel.

In S230, the target body region of the to-be-monitored object is determined according to the attribute information of the target pixel and the preliminary body region.

In this embodiment, the target body region of the to-be-monitored object may be determined according to the determined attribute information of the target pixel and the preliminary body region of the to-be-monitored object. Exemplarily, a pixel in the target pixels whose attribute information is a monitoring object pixel may be considered as a part of the target body region, a pixel in the target pixels whose attribute information is an edge pixel may be considered as a pixel located at the edge of the contour of the to-be-monitored object, and a pixel in the target pixels whose attribute information is other information may be considered as a pixel of the object other than the to-be-monitored object. Thus, in this embodiment, the pixel in the target pixels whose attribute information is the monitoring object pixel and/or the edge pixel and the preliminary body region may be comprehensively used for determining the target body region of the to-be-monitored object. Other target pixels are not involved in determining the target body region of the to-be-monitored object.

In S240, echo signal information near a target detection point in the to-be-monitored object is received, where the target detection point is a central point of a target axis in the target body region of the to-be-monitored object, and the echo signal information is information about an echo signal corresponding to a radar signal emitted near the target detection point.

In S250, relative distance information of a target to-be-monitored object is determined based on the echo signal information, and when the relative distance information does not satisfy preset distance information, an alarm signal is generated to perform an early warning processing.

According to the object-based distance monitoring method provided in embodiment two of the present disclosure, the preliminary body region of the to-be-monitored object is determined based on the color temperature of the infrared thermal image; for a target pixel in the infrared thermal image, the attribute information of the target pixel is determined based on the color temperature value of the target pixel; and the target body region of the to-be-monitored object is determined according to the attribute information of the target pixel and the preliminary body region; the echo signal information near the target detection point in the to-be-monitored object is received, where the target detection point is the central point of the target axis in the target body region of the to-be-monitored object, and the echo signal information is the information about the echo signal corresponding to the radar signal emitted near the target detection point; the relative distance information of the target to-be-monitored object is determined based on the echo signal information, and when the relative distance information of the target to-be-monitored object does not satisfy the preset distance information, the alarm signal is generated to perform the early warning processing. By utilizing this method, the attribute information of the target pixel and the preliminary body region are determined, which provides a basis for accurately determining the target body region of the to-be-monitored object, further improves the accuracy of subsequent determination of the relative distance information, and thus reduces the safety hazards.

In some embodiments, the step in which the attribute information of the target pixel is determined based on the color temperature value of the target pixel includes the following steps: Whether the color temperature value of the target pixel satisfies a preset color temperature condition is determined, where the preset color temperature condition is determined by the maximum color temperature value of the infrared thermal image and a preset color temperature threshold; if the color temperature value of the target pixel satisfies the preset color temperature condition, it is determined whether color temperature values of all pixels in a preset target region satisfy the preset color temperature condition, and the attribute information of the target pixel is determined according to a determination result; and if the color temperature value of the target pixel does not satisfy the preset color temperature condition, the attribute information of the target pixel is determined as a background pixel.

The preset color temperature condition may be considered as a preset condition and used for determining the attribute information of the target pixel, for example, the preset color temperature condition may be a color temperature value range corresponding to the to-be-monitored object. The preset color temperature condition may be determined by the highest color temperature value of the infrared thermal image and the preset color temperature threshold. The highest color temperature value is the value of the highest color temperature in the infrared thermal image. The preset color temperature threshold may be a preset color temperature value for measuring the lowest color temperature of the to-be-monitored object, and the preset color temperature threshold may be an empirical value determined by the configuration personnel.

The preset target region may be understood as a preset target region. For example, the preset target region may be a region formed by using the target pixel as a center. The size of the preset target region is not limited and may be determined according to practical conditions. The background pixel is a pixel belonging to the background part, for example, the background may be a fixed building, a baffle, and/or a plant pot, and the like.

In some embodiments, during the process of determining the attribute information of the target pixel, whether the color temperature value of the target pixel satisfies the preset color temperature condition may be determined first. Exemplarily, whether the color temperature value of the target pixel is lower than the maximum color temperature value and higher than a difference between the maximum color temperature value and the preset color temperature threshold may be determined according to the magnitude of the color temperature value of the target pixel. If the preset color temperature condition described above is satisfied, it represents that the color temperature value of the target pixel is within the color temperature value range corresponding to the to-be-monitored object, whether the color temperature values of all pixels in the preset target region satisfy the preset color temperature condition may be further determined to obtain a determination result, and the attribute information of the target pixel is determined according to the obtained determination result. If the preset color temperature condition described above is not satisfied, it represents that the color temperature value of the target pixel is not within the color temperature value range corresponding to the to-be-monitored object, and the attribute information of the target pixel may be determined as the background pixel.

In some embodiments, the step in which the attribute information of the target pixel is determined according to the determination result includes the following steps: If the determination result is that the color temperature values of all pixels in the preset target region satisfy the preset color temperature condition, the attribute information of the target pixel is determined as a monitoring object pixel; or if the determination result is that the color temperature values of all pixels in the preset target region do not satisfy the preset color temperature condition, the attribute information of the target pixel is determined as an edge pixel.

The monitoring object pixel may refer to a pixel corresponding to the to-be-monitored object. The edge pixel may refer to a pixel located at the edge of the to-be-monitored object, such as a critical pixel located at the intersection between the to-be-monitored object and the background.

In some embodiments, if the color temperature values of all pixels in the preset target region including the target pixel satisfy the preset color temperature condition, it represents that the color temperature values of the target pixel and the surrounding pixels are within the color temperature value range corresponding to the to-be-monitored object, and it further represents that the target pixel is the pixel corresponding to the to-be-monitored object. At this time, the attribute information of the target pixel may be determined as the monitoring object pixel. If the color temperature values of all pixels in the preset target region including the target pixel do not satisfy the preset color temperature condition, for example, if the color temperature value of at least one pixel does not satisfy the preset color temperature condition, it represents that the color temperature values of the target pixel and the surrounding pixels are not all within the color temperature value range corresponding to the to-be-monitored object, and at this time, the attribute information of the target pixel may be determined as the edge pixel.

FIG. 4 is a schematic diagram of an object-based distance monitoring method according to embodiment two of the present disclosure. As shown in FIG. 4, the description is given by using an example in which the object is the crowd and the object-based distance monitoring system is a crowd congestion detection system. A detection process of a crowd congestion condition may be monitored by the crowd congestion detection system, and the system may be applied in places where people are gathered in large quantities. Furthermore, the number of crowd congestion detection systems may be determined according to the condition of the place, the place may be outdoors or indoors, and the crowd congestion detection system may be used only at night when being applied outdoors, to avoid excessive noise interference caused by the ambient temperature and an excessive influence caused by the ambient temperature on the effectiveness of detecting an infrared thermal image. At the same time, the crowd congestion detection system also needs to be arranged at a high location, usually on the second floor or a higher floor, so a large number of people may be detected in the top view angle, to avoid the radar measurement misalignment caused by a high obstruction in the radar detection. In some embodiments, an infrared thermal image is acquired by means of the crowd congestion detection system, and human-shaped cutting is performed on the infrared thermal image (that is, the target body region of the to-be-monitored object in the infrared thermal image is determined based on the acquired color temperature of the infrared thermal image), further, the measurement distance, the movement speed, the human body breathing and the human body heartbeat are obtained by means of Doppler radar detection (that is, the life characterization information of the to-be-monitored object is determined based on the echo signal information); an infrared human-shaped image interval detection is performed according to the acquired information (that is, the relative distance information of the target to-be-monitored object is determined based on the echo signal information), and a crowd congestion warning is performed when the interval reaches a limit value (that is, when the relative distance information does not satisfy the preset distance information, the alarm signal is generated to perform the early warning processing), thereby achieving the detection of the crowd congestion condition.

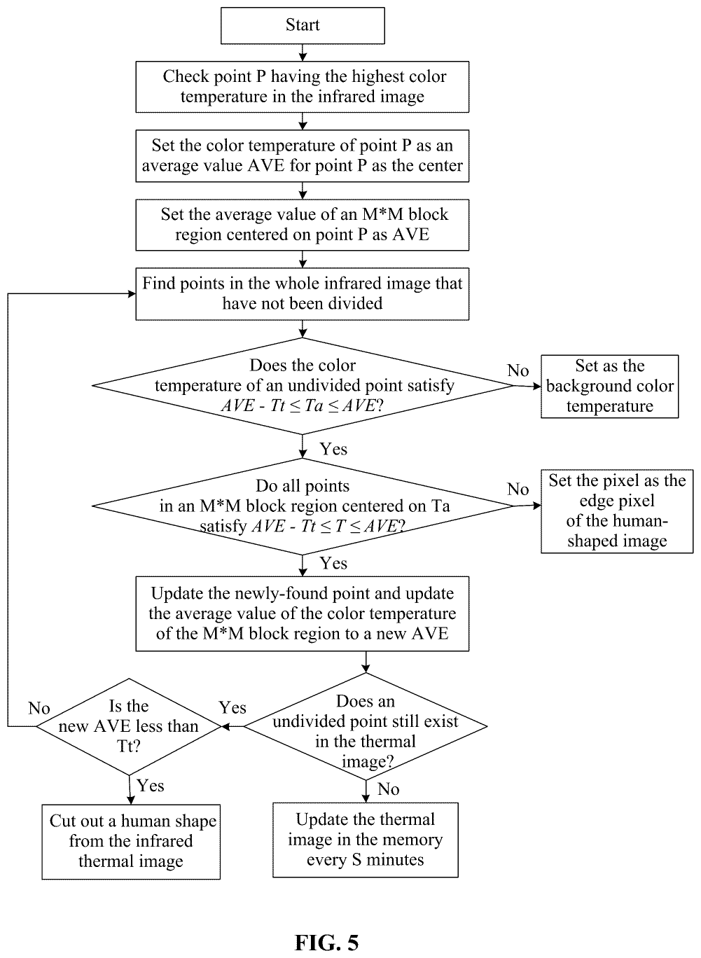

FIG. 5 is a flowchart of a process for determining a target body region of a to-be-monitored object according to embodiment two of the present disclosure. As shown in FIG. 5, point P having the highest color temperature in the infrared image may be checked first, and the color temperature value of point P is set as an average value AVE, that is, the average value of an M*M block region having point P as the center is set as AVE. After the body region of the to-be-monitored object is preliminarily determined based on the color temperature of the infrared thermal image (that is, the preliminary body region of the to-be-monitored object is determined based on the color temperature of the infrared thermal image), a point (that is, a target pixel) in the whole infrared thermal image that has not been divided may be found, and whether the color temperature Ta of the target pixel satisfies AVE−Tt≤Ta≤AVE is determined (that is, whether the color temperature value of the target pixel satisfies the preset color temperature condition is determined, the preset color temperature condition is determined by the maximum color temperature value of the infrared thermal image and the preset color temperature threshold), where Tt may be a preset empirical value. If the color temperature Ta of the target pixel does not satisfy AVE−Tt≤Ta≤AVE, the color temperature of the pixel may be set as the background color temperature (that is, if the color temperature value of the target pixel does not satisfy the preset color temperature condition, the attribute information of the target pixel is determined as the background pixel).

If the color temperature Ta of the target pixel satisfies AVE−Tt≤Ta≤AVE, whether color temperature values T of points in the M*M block region centered on the pixel satisfy AVE Tt≤T≤AVE may be further determined (that is, if the color temperature value of the target pixel satisfies the preset color temperature condition, whether the color temperature values of all pixels in the preset target region satisfy the preset color temperature condition is determined). If not all color temperature values T of the points in the M*M block region centered on the pixel satisfy AVE−Tt≤T≤AVE, the pixel may be set as an edge pixel of the human-shaped image. If all the color temperature values T of the points in the M*M block region centered on the pixel satisfy AVE−Tt≤T≤AVE, the pixel may be considered as the pixel corresponding to the to-be-monitored object (that is, if the determination result is that color temperature values of all pixels in the preset target region satisfy the preset color temperature condition, the attribute information of the target pixel is determined as the monitoring object pixel; otherwise, the attribute information of the target pixel is determined as the edge pixel), the newly-found point and the average value of the color temperature of the M*M block region centered on the newly-found point are determined and the average value is updated to a new AVE, and whether an undivided point still exists in the thermal image is determined. If the undivided point still exists in the thermal image, when the new AVE is greater than or equal to Tt, it is returned to executing the step of finding the point in the whole infrared image that has not been divided, and when the new AVE is less than Tt, it is considered that a human shape has been cut out from the infrared thermal image, and the operation performed on the infrared thermal image may end. If the undivided point does not exist in the thermal image, it may also be considered that the human shape has been cut out from the infrared thermal image. The thermal image in the memory may be updated every S minutes, and the above-described operations may continue to be performed on the updated thermal image.

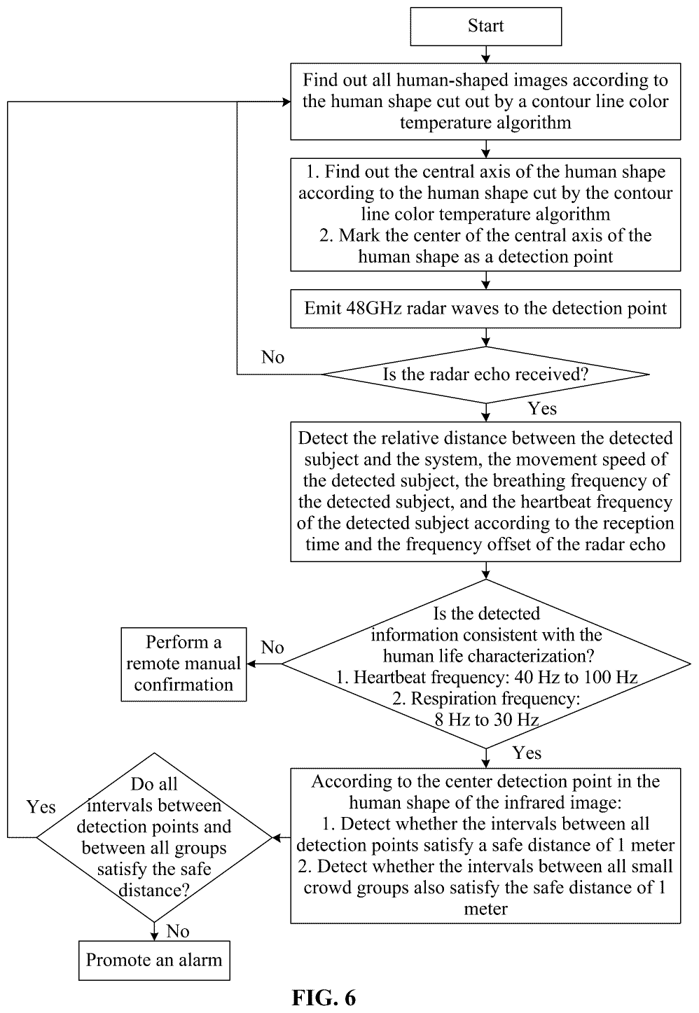

FIG. 6 is a flowchart of a process for determining relative distance information of a target to-be-monitored object according to embodiment two of the present disclosure. As shown in FIG. 6, by means of the above-described steps, after all human-shaped images are determined according to the human shape cut out by the contour line color temperature algorithm, the center axis of the human-shaped image may be found, and the center of the center axis of the human-shaped image may be marked as a detection point (that is, the target detection point is the central point of the target axis in the target body region of the to-be-monitored object). Then the 48 GHz radar waves are emitted to each detection point (that is, the echo signal information near the target detection point in the to-be-monitored object is received, where the echo signal information is information for an echo signal corresponding to a radar signal emitted near the target detection point), and whether the radar echo is received is determined, and when the echo signals corresponding to all radar waves are received, a relative distance between the detected subject and the system, a movement speed of the detected subject, a breathing frequency of the detected subject, and a heartbeat frequency of the detected subject are detected according to the reception time and the frequency offset of the radar echo (that is, the life characterization information of the to-be-monitored object is determined based on the echo signal information, and the relative distance information of the target to-be-monitored object is determined based on the echo signal information); whether the detected information is consistent with the human life characterization is determined (that is, whether the life characterization information satisfies the preset characterization information is determined, and the to-be-monitored object whose life characterization information satisfies the preset characterization information is determined as the target to-be-monitored object), where the human life characterization (that is, the preset characterization information) includes the heartbeat frequency of 40 Hz to 100 Hz and the respiration frequency of 8 Hz to 30 Hz. If the detected information is not consistent with the human life characterization, a manual confirmation is performed at the remote end. If the detected information is consistent with the human life characterization, whether the intervals between all detection points satisfy a safe distance is detected according to the central detection point in the human shape in the infrared image (that is, a calculation is performed on the echo signal information to obtain the relative distance information of the target detection point in the target to-be-monitored object, and whether the relative distance information satisfies the preset distance information is determined). Meanwhile, it is also detected whether the intervals between all small crowd groups also satisfy the safe distance (that is, at least two target to-be-monitored objects in the infrared thermal image are divided into two monitoring individuals; the relative distance information of each monitoring individual is determined according to the echo signal information corresponding to the monitoring individual, and whether the relative distance information satisfies the preset distance information is determined). For example, the safe distance (that is, the preset distance information) is set to 1 m. If all the intervals between all detection points and between all groups satisfy the safe distance, it represents that the distances between people and between crowds are in a safe range. If one of the intervals between all detection points and between all groups does not satisfy the safe distance, an alarm is prompted (that is, the alarm signal is generated to perform the early warning processing, when the relative distance information does not satisfy the preset distance information).

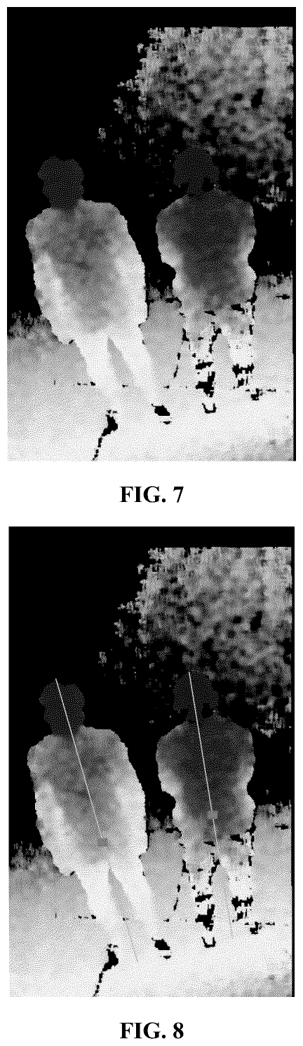

FIG. 7 is a schematic diagram of a target body region of a to-be-monitored object according to embodiment two of the present disclosure. As shown in FIG. 7, a human shape, that is, the target body region, may be cut out from an infrared thermal image captured by the system using the contour line color temperature algorithm of FIG. 5.

FIG. 8 is a schematic diagram of determining a target detection point according to embodiment two of the present disclosure. As shown in FIG. 8, the center axis of the human shape may be found by using the crowd congestion detection algorithm in FIG. 6, and the center of the center axis of the human shape is marked as the detection point, that is, the target detection point.

### Embodiment Three

FIG. 9 is a schematic structural diagram of an object-based distance monitoring apparatus according to embodiment three of the present disclosure. As shown in FIG. 9, the apparatus includes a first determination module 310, a reception module 320 and a second determination module 330.

The first determination module 310 is configured to determine, based on acquired color temperature of an infrared thermal image, a target body region of a to-be-monitored object in the infrared thermal image.

The reception module 320 is configured to receive echo signal information near a target detection point in the to-be-monitored object, where the target detection point is a central point of a target axis in the target body region of the to-be-monitored object, and the echo signal information is information about an echo signal corresponding to a radar signal emitted near the target detection point.

The second determination module 330 is configured to determine, based on the echo signal information, relative distance information of a target to-be-monitored object, and when the relative distance information of the target to-be-monitored object does not satisfy preset distance information, generate an alarm signal to perform an early warning processing.

According to the object-based distance monitoring apparatus provided in embodiment three of the present disclosure, the target body region of the to-be-monitored object in the infrared thermal image is determined by the first determination module based on the acquired color temperature of the infrared thermal image; the echo signal information near the target detection point in the to-be-monitored object is received by the reception module, the target detection point is the central point of the target axis in the target body region of the to-be-monitored object, and the echo signal information is the information about the echo signal corresponding to the radar signal emitted near the target detection point; and the relative distance information of the target to-be-monitored object is determined by the second determination module based on the echo signal information, and when the relative distance information of the target to-be-monitored object does not satisfy the preset distance information, the alarm signal is generated by the second determination module to perform the early warning processing. By utilizing this apparatus, the infrared thermal image is acquired by using the integrated optical technology and the echo signal information at the target detection point in the to-be-monitored object is received by using the radar technology so that the relative distance information of the target to-be-monitored object can be determined, whereby the accuracy of the monitoring result is improved and the potential safety hazards are reduced on the basis of achieving the trample prevention monitoring for foot traffic.

In some embodiments, the first determination module 310 may include a first determination unit, a second determination unit and a third determination unit.

The first determination unit is configured to determine a preliminary body region of the to-be-monitored object based on the color temperature of the infrared thermal image.

The second determination unit is configured to, for a target pixel in the infrared thermal image, determine attribute information of the target pixel based on a color temperature value of the target pixel.

The third determination unit is configured to determine the target body region of the to-be-monitored object according to the attribute information of the target pixel and the preliminary body region.

In some embodiments, the second determination unit may include a determination subunit, a first determination subunit and a second determination subunit.

The determination subunit is configured to determine whether the color temperature value of the target pixel satisfies a preset color temperature condition, and the preset color temperature condition is determined by the maximum color temperature value of the infrared thermal image and a preset color temperature threshold.

The first determination subunit is configured to, if the color temperature value of the target pixel satisfies the preset color temperature condition, determine whether color temperature values of all pixels in a preset target region satisfy the preset color temperature condition, and determine the attribute information of the target pixel according to a determination result.

The second determination subunit is configured to, if the color temperature value of the target pixel does not satisfy the preset color temperature condition, determine the attribute information of the target pixel as a background pixel.

In some embodiments, the first determining sub-unit may be configured to, if the determination result is that the color temperature values of all pixels in the preset target region satisfy the preset color temperature condition, determine the attribute information of the target pixel as a monitoring object pixel; or if the determination result is that the color temperature values of all pixels in the preset target region do not satisfy the preset color temperature condition, determine the attribute information of the target pixel as an edge pixel.

Alternatively, the object-based distance monitoring apparatus according to embodiment three of the present disclosure further includes a third determination module and a fourth determination module.

The third determination module is configured to determine life characterization information of the to-be-monitored object based on the echo signal information, before the relative distance information of the target to-be-monitored object is determined based on the echo signal information.

The fourth determination module is configured to, before the relative distance information of the target to-be-monitored object is determined based on the echo signal information, determine whether the life characterization information satisfies preset characterization information and determine the to-be-monitored object whose life characterization information satisfies the preset characterization information as the target to-be-monitored object.

In some embodiments, the second determination module 330 may be configured to perform a calculation on the echo signal information to obtain the relative distance information of the target detection point in the target to-be-monitored object.

In some embodiments, the second determination module 330 may be configured to divide at least two target to-be-monitored objects in the infrared thermal image into two monitoring individuals, and determine relative distance information of each monitoring individual according to echo signal information corresponding to the monitoring individual.

The object-based distance monitoring apparatus provided in the embodiments of the present disclosure may perform the object-based distance monitoring method provided in any one of the embodiments of the present disclosure, and has corresponding functional modules and beneficial effects for executing the method.

### Embodiment Four

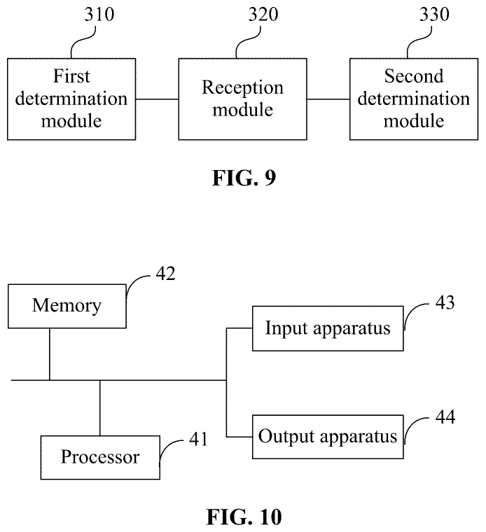

FIG. 10 is a schematic structural diagram of an object-based distance monitoring system according to embodiment four of the present disclosure. As shown in FIG. 10, the system provided in embodiment four of the present disclosure includes one or more processors 41 and a memory 42. The number of processors 41 in the system may be one or more, for example, one processor 41 is used as an example in FIG. 10. The memory 42 is configured to store one or more programs. When executed by the one or more processors 41, the one or more programs are configured to cause the one or more processors 41 to implement the object-based distance monitoring method described in any one of the embodiments of the present disclosure.

The system may further include an input apparatus 43 and an output apparatus 44.

The processor 41, the memory 42, the input apparatus 43 and the output apparatus 44 in the system may be connected via a bus or other manners, for example, the connection via the bus is used as an example in FIG. 10.

The memory 42 in the system serves as a computer-readable storage medium and may be used for storing one or more programs, and the program may be a software program, a computer-executable program, and a module, such as a program instruction/module corresponding to the object-based distance monitoring method provided in embodiment one or embodiment two of the present disclosure (for example, the modules in the object-based distance monitoring apparatus shown in FIG. 9, including the first determination module 310, the reception module 320, and the second determination module 330). The processor 41 executes various functional applications and data processing of the system by running software programs, instructions and modules stored in the memory 42, that is, implements the object-based distance monitoring method in the above-described method embodiments.

The memory 42 may mainly include a storage program region and a storage data region, where the storage program region may store an operating system, and an application program required for at least one function. The storage data region may store data and the like created according to the use of the system. Moreover, the memory 42 may include a high-speed random access memory and may also include a non-volatile memory, such as at least one magnetic disk storage device, a flash memory device, or other non-volatile solid state storage device. In some instances, the memory 42 may further include a memory disposed remotely relative to the processor 41, and the remote memory may be connected to the device over a network. Instances of such networks include, but are not limited to, the Internet, an intranet, a local area network, a mobile communication network, and combinations thereof.

The input apparatus 43 may be configured to receive the input numeric or character information and to generate key signal inputs related to user settings and functional control of the system. The output apparatus 44 may include a display apparatus such as a display screen.

When one or more programs included in the system described above are executed by the one or more processors 41, the program performs the following operations: A target body region of a to-be-monitored object in an infrared thermal image is determined based on acquired color temperature of the infrared thermal image; echo signal information near a target detection point in the to-be-monitored object is received, where the target detection point is a central point of a target axis in the target body region of the to-be-monitored object, and the echo signal information is information about an echo signal corresponding to a radar signal emitted near the target detection point; and relative distance information of a target to-be-monitored object is determined based on the echo signal information, and in a case where the relative distance information of the target to-be-monitored object does not satisfy preset distance information, an alarm signal is generated to perform an early warning processing

In some embodiments, the system further includes an imaging system and a radar system. The imaging system is configured to output the infrared thermal image to the processor, and the radar system is configured to emit the radar signal, receive the echo signal corresponding to the radar signal, and send the echo signal information to the at least one processor.

The imaging system may refer to a device for acquiring the infrared thermal image. For example, the imaging system may include at least one of a lens module, an image sensor, a filter, or an image processor. The radar system may be configured to emit the radar signal and receive the echo signal. The structure of the radar system is not limited in the present disclosure, and may be configured according to practical conditions. For example, the radar system may include a radar TX RF module, a radar RX RF module, a radio frequency amplifier, and the like.

In some embodiments, the system further includes an illumination assisting module configured to assist the imaging system in acquiring the thermal image.

In some embodiments, the system further includes an alarm module, and the alarm module is configured to perform the early warning process when the relative distance information does not satisfy the preset distance information.

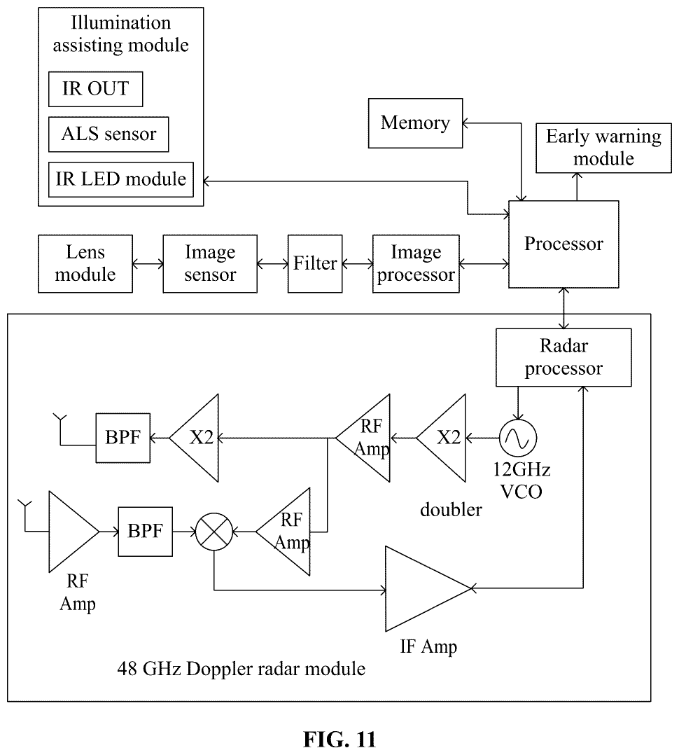

FIG. 11 is a schematic structural diagram of another object-based distance monitoring system according to embodiment four of the present disclosure. As shown in FIG. 11, the object-based distance monitoring system serving as a crowd congestion detection system is used as an example, the crowd congestion detection system may include a processor, an early warning module (i.e., the alarm module), a memory, an imaging system, an illumination assisting module (i.e., the illumination assisting module), and a 48 GHz Doppler radar module (i.e., the radar system). The imaging system may include the image processor, the filter, the image sensor, and the lens module. The illumination assisting module may include an IR LED module, an ALS sensor, and an IR CUT. The 48 GHz Doppler radar module may include a radar processor, a band pass filter (BPF), an intermediate frequency amplifier (IF Amp), and the like.

### Embodiment Five

Embodiment five of the present disclosure provides a computer-readable storage medium. The computer-readable storage medium stores a computer program, and the computer program is configured to, when executed by a processor, perform the object-based distance monitoring method. The method includes the following:

A target body region of a to-be-monitored object in an infrared thermal image is determined based on acquired color temperature of the infrared thermal image; echo signal information near a target detection point in the to-be-monitored object is received, where the target detection point is a central point of a target axis in the target body region of the to-be-monitored object, and the echo signal information is information about an echo signal corresponding to a radar signal emitted near the target detection point; and relative distance information of a target to-be-monitored object is determined based on the echo signal information, and when the relative distance information of the target to-be-monitored object does not satisfy preset distance information, an alarm signal is generated to perform an early warning processing.

When the program is executed by the processor, the program is further configured to perform the object-based distance monitoring method provided in any one of the embodiments of the present disclosure.

The computer storage media of the embodiments of the present disclosure may adopt any combination of one or more computer-readable media. The computer-readable medium may be a computer-readable signal medium or a computer-readable storage medium. The computer-readable storage medium may be, for example, but not limited to, an electronic, magnetic, optical, electromagnetic, infrared, or semiconductor system, apparatus, or device, or any combination of the foregoing. More examples (a non-exhaustive list) of the computer-readable storage medium include an electrical connection having one or more wires, a portable computer diskette, a hard disk, a random access memory (RAM), a read-only memory (ROM), an erasable programmable read-only memory (EPROM), a flash memory, an optical fiber, a portable compact disc read-only memory (CD-ROM), an optical storage device, a magnetic storage device, or any suitable combination of the foregoing. The computer-readable storage medium may be any tangible medium that contains or stores a program, and the program is used for use by or in connection with an instruction execution system, apparatus, or device.

The computer-readable signal medium may include a data signal propagated in a baseband or as part of a carrier wave, and a computer-readable program code is carried in the data signal. Such a propagated data signal may adopt a variety of forms, including, but not limited to: an electromagnetic signal, an optical signal, or any suitable combination of the foregoing. The computer-readable signal medium may be any computer-readable medium that is not a computer-readable storage medium, and the computer-readable medium may send, propagate, or transport a program for use by or in connection with an instruction execution system, apparatus, or device.

Program codes embodied on the computer-readable medium may be transmitted using any appropriate medium, including but not limited to: wireless, wire, optic cable, radio frequency (RF) and the like, or any suitable combination of the foregoing.

A computer program code for performing the operations of the present disclosure may be written in one or more programming languages or combinations thereof, the described programming languages include an object-oriented programming language such as Java, Smalltalk, C++, and further include a conventional procedural programming language such as a “C” language or similar programming language. The program code may be executed in the following manners: executed entirely on a user's computer, executed partly on the user's computer, executed as an independent software package, executed partly on the user's computer and partly on a remote computer, or executed entirely on the remote computer or a server. In a case where the remote computer is involved, the remote computer may be connected to the user's computer through any kind of network, including a local area network (LAN) or a wide area network (WAN), or may be connected to an external computer (for example, connected to the external computer through an internet provided by an internet service provider).

It should be noted that the above-described contents are only the exemplary embodiments of the present disclosure and the technical principles applied thereto. It should be understood by those skilled in the art that the present disclosure is not limited to the particular embodiments described herein, and that various variations, rearrangements and substitutions may be made without departing from the protection scope of the present disclosure. Therefore, although the present disclosure has been described in detail with reference to the above embodiments, the present disclosure is not limited to the above embodiments, and may further include other equivalent embodiments without departing from the concept of the present disclosure, and the scope of the present disclosure is defined by the appended claims.

What is claimed is:

1. An object-based distance monitoring method, comprising:
determining, based on acquired color temperature of an infrared thermal image, a target body region of a to-be-monitored object in the infrared thermal image;
receiving echo signal information near a target detection point in the to-be-monitored object, wherein the target detection point is a central point of a target axis in the target body region of the to-be-monitored object, and the echo signal information is information about an echo signal corresponding to a radar signal emitted near the target detection point; and
determining, based on the echo signal information, relative distance information of a target to-be-monitored object, and in a case where the relative distance information does not satisfy preset distance information, generating an alarm signal to perform an early warning processing.

2. The object-based distance monitoring method of claim 1, wherein determining, based on the acquired color temperature of the infrared thermal image, the target body region of the to-be-monitored object in the infrared thermal image comprises:
determining, based on the color temperature of the infrared thermal image, a preliminary body region of the to-be-monitored object;
for a target pixel in the infrared thermal image, determining attribute information of the target pixel based on a color temperature value of the target pixel; and
determining, according to the attribute information of the target pixel and the preliminary body region, the target body region of the to-be-monitored object.

3. The object-based distance monitoring method of claim 2, wherein determining the attribute information of the target pixel based on the color temperature value of the target pixel comprises:
determining whether the color temperature value of the target pixel satisfies a preset color temperature condition, wherein the preset color temperature condition is determined by a maximum color temperature value of the infrared thermal image and a preset color temperature threshold;
in a case where the color temperature value of the target pixel satisfies the preset color temperature condition, determining whether color temperature values of all pixels in a preset target region satisfy the preset color temperature condition, and determining the attribute information of the target pixel according to a determination result; and
in a case where the color temperature value of the target pixel does not satisfy the preset color temperature condition, determining the attribute information of the target pixel as a background pixel.

4. The object-based distance monitoring method of claim 3, wherein determining the attribute information of the target pixel according to the determination result comprises:
in a case where the determination result is that the color temperature values of all pixels in the preset target region satisfy the preset color temperature condition, determining the attribute information of the target pixel as a monitoring object pixel; or in a case where the determination result is that the color temperature values of all pixels in the preset target region do not satisfy the preset color temperature condition, determining the attribute information of the target pixel as an edge pixel.

5. The object-based distance monitoring method of claim 1, wherein before determining, based on the echo signal information, the relative distance information of the target to-be-monitored object, the method further comprises:
determining life characterization information of the to-be-monitored object based on the echo signal information; and
determining whether the life characterization information satisfies preset characterization information, and determining the to-be-monitored object whose life characterization information satisfies the preset characterization information as the target to-be-monitored object.

6. The object-based distance monitoring method of claim 1, wherein determining, based on the echo signal information, the relative distance information of the target to-be-monitored object comprises:
performing a calculation on the echo signal information to obtain the relative distance information of the target detection point in the target to-be-monitored object.

7. The object-based distance monitoring method of claim 1, wherein determining, based on the echo signal information, the relative distance information of the target to-be-monitored object comprises:
dividing at least two target to-be-monitored objects in the infrared thermal image into two monitoring individuals; and
determining, according to echo signal information corresponding to each of the two monitoring individuals, relative distance information of each of the two monitoring individuals.

8. An object-based distance monitoring system, comprising:
at least one processor; and
a memory communicatively connected to the at least one processor;
wherein the memory stores a computer program executable by the at least one processor, and the computer program, when executed by the at least one processor, causes the at least one processor to perform the following:
determining, based on acquired color temperature of an infrared thermal image, a target body region of a to-be-monitored object in the infrared thermal image;
receiving echo signal information near a target detection point in the to-be-monitored object, wherein the target detection point is a central point of a target axis in the target body region of the to-be-monitored object, and the echo signal information is information about an echo signal corresponding to a radar signal emitted near the target detection point; and
determining, based on the echo signal information, relative distance information of a target to-be-monitored object, and in a case where the relative distance information does not satisfy preset distance information, generating an alarm signal to perform an early warning processing.

9. The object-based distance monitoring system of claim 8, further comprising an imaging system and a radar system,
wherein the imaging system is configured to output the infrared thermal image to the at least one processor, and the radar system is configured to emit the radar signal, receive the echo signal corresponding to the radar signal, and send the echo signal information to the at least one processor.

10. The object-based distance monitoring system of claim 8, wherein the at least one processor is caused to perform determining, based on the acquired color temperature of the infrared thermal image, the target body region of the to-be-monitored object in the infrared thermal image by:
determining, based on the color temperature of the infrared thermal image, a preliminary body region of the to-be-monitored object;
for a target pixel in the infrared thermal image, determining attribute information of the target pixel based on a color temperature value of the target pixel; and
determining, according to the attribute information of the target pixel and the preliminary body region, the target body region of the to-be-monitored object.

11. The object-based distance monitoring system of claim 10, wherein the at least one processor is caused to perform determining the attribute information of the target pixel based on the color temperature value of the target pixel by:
determining whether the color temperature value of the target pixel satisfies a preset color temperature condition, wherein the preset color temperature condition is determined by a maximum color temperature value of the infrared thermal image and a preset color temperature threshold;
in a case where the color temperature value of the target pixel satisfies the preset color temperature condition, determining whether color temperature values of all pixels in a preset target region satisfy the preset color temperature condition, and determining the attribute information of the target pixel according to a determination result; and
in a case where the color temperature value of the target pixel does not satisfy the preset color temperature condition, determining the attribute information of the target pixel as a background pixel.

12. The object-based distance monitoring system of claim 11, wherein the at least one processor is caused to perform determining the attribute information of the target pixel according to the determination result by:
in a case where the determination result is that the color temperature values of all pixels in the preset target region satisfy the preset color temperature condition, determining the attribute information of the target pixel as a monitoring object pixel; or in a case where the determination result is that the color temperature values of all pixels in the preset target region do not satisfy the preset color temperature condition, determining the attribute information of the target pixel as an edge pixel.

13. The object-based distance monitoring system of claim 8, wherein before determining, based on the echo signal information, the relative distance information of the target to-be-monitored object, the at least one processor is caused to further perform:
determining life characterization information of the to-be-monitored object based on the echo signal information; and
determining whether the life characterization information satisfies preset characterization information, and determining the to-be-monitored object whose life characterization information satisfies the preset characterization information as the target to-be-monitored object.

14. The object-based distance monitoring system of claim 8, wherein the at least one processor is caused to perform determining, based on the echo signal information, the relative distance information of the target to-be-monitored object by:
performing a calculation on the echo signal information to obtain the relative distance information of the target detection point in the target to-be-monitored object.

15. The object-based distance monitoring system of claim 8, wherein the at least one processor is caused to perform determining, based on the echo signal information, the relative distance information of the target to-be-monitored object by:
dividing at least two target to-be-monitored objects in the infrared thermal image into two monitoring individuals; and
determining, according to echo signal information corresponding to each of the two monitoring individuals, relative distance information of each of the two monitoring individuals.

16. A non-transitory computer-readable storage medium, storing a computer instruction, wherein the computer instruction is configured to, when executed by a processor, implement the following:
determining, based on acquired color temperature of an infrared thermal image, a target body region of a to-be-monitored object in the infrared thermal image;
receiving echo signal information near a target detection point in the to-be-monitored object, wherein the target detection point is a central point of a target axis in the target body region of the to-be-monitored object, and the echo signal information is information about an echo signal corresponding to a radar signal emitted near the target detection point; and
determining, based on the echo signal information, relative distance information of a target to-be-monitored object, and in a case where the relative distance information does not satisfy preset distance information, generating an alarm signal to perform an early warning processing.

17. The non-transitory computer-readable storage medium of claim 16, wherein the computer instruction is configured to implement determining, based on the acquired color temperature of the infrared thermal image, the target body region of the to-be-monitored object in the infrared thermal image by:
determining, based on the color temperature of the infrared thermal image, a preliminary body region of the to-be-monitored object;
for a target pixel in the infrared thermal image, determining attribute information of the target pixel based on a color temperature value of the target pixel; and
determining, according to the attribute information of the target pixel and the preliminary body region, the target body region of the to-be-monitored object.

18. The non-transitory computer-readable storage medium of claim 17, wherein the computer instruction is configured to implement determining the attribute information of the target pixel based on the color temperature value of the target pixel by:
determining whether the color temperature value of the target pixel satisfies a preset color temperature condition, wherein the preset color temperature condition is determined by a maximum color temperature value of the infrared thermal image and a preset color temperature threshold;
in a case where the color temperature value of the target pixel satisfies the preset color temperature condition, determining whether color temperature values of all pixels in a preset target region satisfy the preset color temperature condition, and determining the attribute information of the target pixel according to a determination result; and
in a case where the color temperature value of the target pixel does not satisfy the preset color temperature condition, determining the attribute information of the target pixel as a background pixel.

19. The non-transitory computer-readable storage medium of claim 18, wherein the computer instruction is configured to implement determining the attribute information of the target pixel according to the determination result by:
in a case where the determination result is that the color temperature values of all pixels in the preset target region satisfy the preset color temperature condition, determining the attribute information of the target pixel as a monitoring object pixel; or in a case where the determination result is that the color temperature values of all pixels in the preset target region do not satisfy the preset color temperature condition, determining the attribute information of the target pixel as an edge pixel.

20. The non-transitory computer-readable storage medium of claim 16, wherein before determining, based on the echo signal information, the relative distance information of the target to-be-monitored object, the computer instruction is configured to further implement:
determining life characterization information of the to-be-monitored object based on the echo signal information; and
determining whether the life characterization information satisfies preset characterization information, and determining the to-be-monitored object whose life characterization information satisfies the preset characterization information as the target to-be-monitored object.
